(19) United States
(12) Patent Application Publication
(10) Pub. No.: US 2024/0380666 A1
(43) Pub. Date: Nov. 14, 2024

(54) ANALYSIS OF TEMPORAL BEHAVIOR IN NETWORK

(71) Applicant: VMware LLC, Palo Alto, CA (US)

(72) Inventors: Santhosh Prabhu Muraleedhara Prabhu, Urbana, IL (US); Giri Prashanth Subramanian, Cupertino, CA (US); Aanand Nayyar, Palo Alto, CA (US); Philip Brighten Godfrey, Champaign, IL (US)

(21) Appl. No.: 18/195,635

(22) Filed: May 10, 2023

(51) Int. Cl. H04L 41/0895; H04L 41/0803; H04L 43/067

(52) U.S. Cl. CPC H04L 41/0895; H04L 41/0803; H04L 43/067

(57) ABSTRACT

Some embodiments provide a method for validating behavior in a network over a duration of time. The method receives a set of conditions for the network over a time duration. The method automatically generates a program that includes a set of variables representing the set of conditions at given time intervals. The method queries a set of network data across the time duration to determine values for the variables at each time interval over the time duration. The method uses a model checker that analyzes the program with the determined values for the variables to determine whether the set of conditions are met for the network over the time duration.

### BACKGROUND

Changes occur regularly in datacenters, with new applications being created, virtual machines (VMs) and containers being brought up, taken down, and migrated, connections being modified, etc. While for the most part such changes are part of the normal operation of the datacenter, some changes are not desired (e.g., links going down, VMs losing connectivity, etc. Despite the availability of many different datacenter management and monitoring tools, detailed monitoring of the evolution of entities over time remains elusive. In order to diagnose and/or prevent outages and vulnerabilities, better temporal monitoring would be useful.

### BRIEF SUMMARY

Some embodiments provide a method for validating temporal behavior in a network (e.g., in a datacenter). In some embodiments, an application or framework is provided with a set of temporal conditions to evaluate for the network (e.g., for a set of entities of the network) over a duration of time and automatically generates a program with a set of variables that represent these conditions at given time intervals (e.g., every 5 minutes). The application queries a set of network data (e.g., a collection of data for all of the entities in the network over the time duration) across the time duration in order to determine values for the program variables at each time interval over the time duration, then uses a model checker that analyzes the generated program (with the variables as determined from querying the network data) in order to determine whether the set of conditions are met for the network entities over the time duration.

In some embodiments, the temporal conditions that the framework is provided to evaluate are expressed as linear temporal logic (LTL) assertions. Such an assertion is given as a set of predicates to apply to a set of network entities and a relationship across the time duration between the predicates for each network entity. LTL assertions describe the evolution of a system (in this case, the datacenter or network) in discrete time intervals, using a combination of Boolean variables and temporal operators. These temporal operators evaluate whether predicates (expressions of Boolean variables) are true at a current time interval or in the future, in some cases based on the truth value of other predicates at the same or other time intervals. For example, a predicate for a virtual machine (VM) could state that the IP address is equal to a specific value, the number of current connections is greater than a specific number, etc. An example temporal assertion using multiple predicates is, e.g., “any VM migrated to a particular host (H1) loses connectivity after 10 minutes”.

In addition to the temporal conditions, the framework is also provided with the set of entities (the scope) for which to evaluate the temporal conditions. The scope can be broad (e.g., all virtual machines (VMs), all network elements, etc.), extremely narrow (a specific VM or container, a specific network element, a specific application, etc.), or in between (e.g., all VMs on a specific host, all hosts in a particular rack of the datacenter, etc.). In some embodiments, the scope is defined as a search query into a network data storage (e.g., a storage compiled for a separate network monitoring and/or evaluation application). The result of this search query is a set of entities for which the assertion should be evaluated.

Upon receiving an assertion to evaluate and a scope of entities for which to evaluate the assertion, in some embodiments the framework generates a program that can be analyzed by the model checker once values are determined for the variables. In some embodiments, the program is generated in a language specific to the model checker used for evaluation. The program, in some embodiments, does not itself include the assertions, but rather is a holder for the Boolean variables representing predicate values over time for each entity in the scope. The program defines an array of entities in the defined scope and, for each entity, defines an array of predicate values (Boolean values). The program is then essentially a loop that, for each time interval, updates all of the predicate values based on the network data.

In some embodiments, prior to executing the program, the framework retrieves the necessary network data (from the network data storage) for each of the entities in order to evaluate the truth values of all of the predicates. Some embodiments generate a complete timeline for each predicate prior to the execution of the program, then generate the arrays of predicate values for each time interval based on this timeline when executing the program.

Some embodiments also reduce the scope of network entities for which (i) the program generates arrays of predicate values and (ii) the model checker evaluates the provided assertion, prior to executing the program. For instance, the scope as defined might be all instances of a given entity type in the network (e.g., all VMs or all top of rack switches), but many of these do not need to be evaluated. If the assertion is that all VMs migrated to a particular host (X) meet some set of conditions after migration, then any VM for which the predicate “VM resides on host X” is false for its entire timeline can be removed from the scope of the evaluation. In some embodiments, the framework generates a parse tree for the assertion and traverses the parse tree to identify cases in which a single predicate (or, in some cases, a group of predicates) being either true or false for the entire timeline will always cause the entire assertion to evaluate to true or false. The framework then identifies entities for which the entire timeline meets these criteria and pre-evaluates the assertion for those entities, removing them from the scope of evaluation.

With the scope defined and the program generated, the assertion can be evaluated by the model checker for each entity in the scope. Some embodiments write the assertion in terms of the Boolean variables in the program then provide these assertions as well as the program to the model checker. The model checker executes the program, using the timelines for the predicates to efficiently generate the arrays of predicate values at each time interval. Based on this execution, the model checker evaluates the assertions using the Boolean values at each time state to determine whether the assertion is met for each entity in the scope. In some embodiments, the assertion for each entity is evaluated as a separate assertion by the model checker. In other embodiments, these assertions are grouped together for evaluation by the model checker. The model checker provides the evaluations back to the framework, which can notify the user (e.g., a network administrator) as to entities for which the assertion is (or is not) met.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a temporal assertion evaluation framework of some embodiments.

FIG. 2 conceptually illustrates a process of some embodiments for validating temporal assertions regarding behavior of a network (e.g., a datacenter) across a time duration.

FIG. 3 conceptually illustrates the reduction of a parse tree.

FIG. 4 illustrates a simplified version of a program generated in some embodiments.

FIG. 5 conceptually illustrates a process of some embodiments for generating entity-predicate timelines.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for validating temporal behavior in a network (e.g., in a datacenter). In some embodiments, an application or framework is provided with a set of temporal conditions to evaluate for the network (e.g., for a set of entities of the network) over a duration of time and automatically generates a program with a set of variables that represent these conditions at given time intervals (e.g., every 5 minutes). The application queries a set of network data (e.g., a collection of data for all of the entities in the network over the time duration) across the time duration in order to determine values for the program variables at each time interval over the time duration, then uses a model checker that analyzes the generated program (with the variables as determined from querying the network data) in order to determine whether the set of conditions are met for the network entities over the time duration.

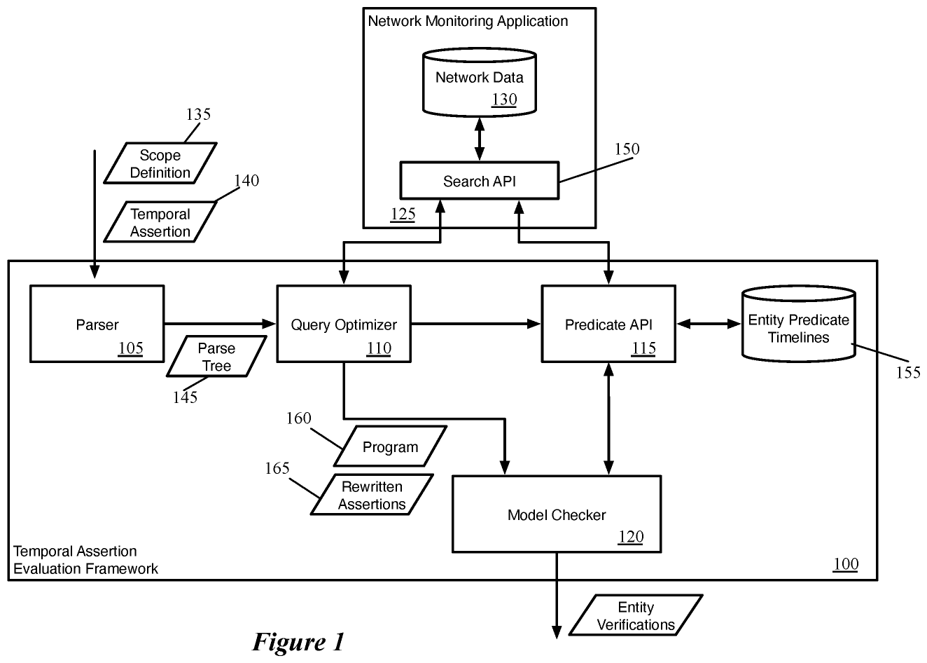

FIG. 1 conceptually illustrates such a temporal assertion evaluation framework 100 of some embodiments. The framework 100 includes a parser 105, a query optimizer 110, a predicate API 115, and a model checker 120. In some embodiments, the model checker 120 is a separate application with which the framework 100 interacts, rather than part of the framework itself. In addition, the framework 100 interacts with a network monitoring application 125 that stores historical network data 130.

As shown, the temporal assertion evaluation framework 100 receives a scope definition 135 and a temporal assertion 140. The scope definition 135 specifies the set of entities for which the temporal assertion 140 will be evaluated, while the temporal assertion specifies the set of conditions for the framework 100 to evaluate for each entity in the scope. In some embodiments, the scope definition 135 and temporal assertion 140 are provided by a user of the framework (e.g., a network administrator, security administrator, etc.).

The parser 105 parses the temporal assertion 140 into a parse tree 145, which is provided to the query optimizer 110. The temporal assertion, in some embodiments, is expressed as a linear temporal logic (LTL) assertion, which is a set of predicates to apply to each entity in the scope and a relationship across a time duration between the predicates. This assertion is parsed into a tree that is a combination of temporal operators, Boolean operators, and predicates.

The query optimizer 110 is responsible for simplifying the scope of entities for which the assertion needs to be evaluated. Initially, the query optimizer 110 analyzes the parse tree 145 to identify situations for which any predicate always being true or always being false for a given entity throughout the entire time duration causes the assertion as a whole to be guaranteed to be true or false for the entity. For instance, if an assertion is “Migration of a VM to Host H1 causes the VM to lose connectivity within 15 minutes”, then any VM for which “host==H1” is false for the entire time duration can be removed from the scope (because this assertion is always false for such VMs).

The query optimizer 110 (as well as the predicate API 115, in some embodiments) interact with a network monitoring application 125 or other application that includes an historical network data store 130. Through a search application programming interface 150 of the network monitoring application 125, the query optimizer 110 retrieves network data for entities within the defined entity scope for the assertion. Using this retrieved network data, the query optimizer 110 is able to reduce the entity scope based on the parse tree analysis (e.g., in the above example, removing from the entity scope any VM that never resides on host H1).

This network data, whether retrieved by the query optimizer 110 or the predicate API 115, is used to generate, for each entity, timelines of truth values for each predicate in the parsed assertion. The framework 100 stores these entity predicate timelines 155 for use during execution of the program. The timeline for a given predicate and entity specifies, for each time interval during the time duration, whether that predicate is true or false for the entity.

The query optimizer 110 also generates a program 160 that can be analyzed by the model checker 120. In some embodiments, the program 160 is generated in a programming language supported by the model checker 120. The program 160, in some embodiments, does not itself include the assertions, but rather is a holder for Boolean variables representing the predicate values over time for each entity in the scope. The program defines an array of entities in the defined scope and, for each entity, defines an array of predicate values (Boolean values). The program is then essentially a loop that, for each time interval, updates all of the predicate values based on the network data.

In order for the model checker 120 to evaluate the temporal assertion 140, the query optimizer also rewrites the assertion using the Boolean variables in the generated program 160. In some embodiments, the assertion is rewritten as many separate assertions (one for each entity in the scope), as the model checker 120 evaluates the assertion for each individual entity. The program 160 and these rewritten assertions are provided to the model checker 120, which executes the program 155 and evaluates the assertions 165.

The program 155 is written as a set of repeated calls to the predicate API 115 to populate values for the Boolean variables (representing the predicates for each entity). The model checker executes the program 155 by making calls to the predicate API 115 at each time interval, which provides the requested truth values from the stored entity predicate timelines 155. Using the populated Boolean variables, the model checker 120 can evaluate the assertions 165 at each time interval to determine whether the assertions are met. The model checker 120 outputs a verification 170 for each entity in the scope, specifying whether the provided assertion is true for each entity. This data can help a user troubleshoot or otherwise evaluate the datacenter/network.

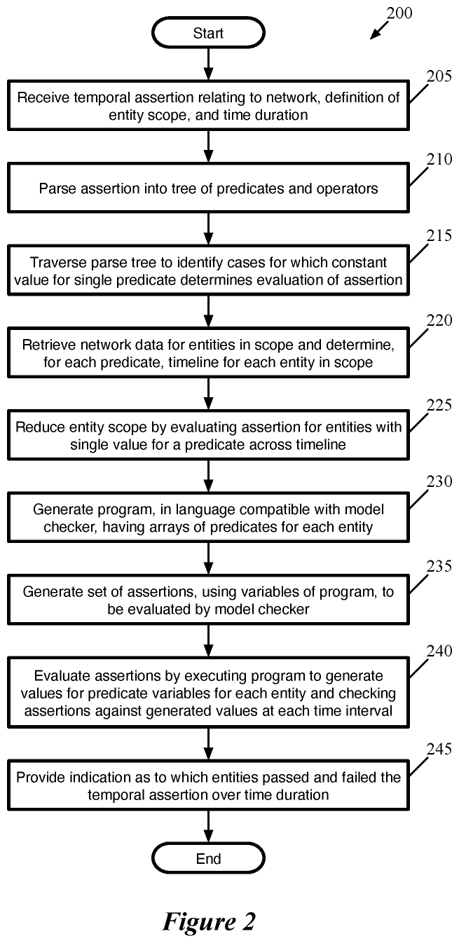

FIG. 2 conceptually illustrates a process 200 of some embodiments for validating temporal assertions regarding behavior of a network (e.g., a datacenter) across a time duration. The process 200 is performed, in some embodiments, by a temporal assertion evaluation framework such as that shown in FIG. 1. The following will provide additional description of the operation of the modules 105-120 of the evaluation framework 100.

As shown, the process 200 begins by receiving (at 205) a temporal assertion relating to a network, a definition of entity scope for evaluating the temporal assertion, and a time duration over which to evaluate the assertion. The assertion, scope, and time duration are received from a user in some embodiments (e.g., a network administrator, security administrator, etc.).

The temporal assertion, in some embodiments, is an assertion about the network that requires evaluation over multiple time intervals. Whereas a condition such as “VM1 resides on host H1” can be verified simply by evaluating the current status of VM1, the assertion “any web server VM belonging to an application is migrated to a host within 5 minutes of a database server VM belonging to that application being migrated to the host” requires temporal logic to verify. Simply evaluating the status of web server and database server VMs at a given time cannot provide the answer as to whether this assertion holds or not. The temporal assertions provided to the verification framework may be associated with desirable conditions (e.g., “hot standby router protocol (HSRP) primary is never down for more than 15 minutes and the standby is up whenever the primary is down”) as well as undesirable conditions (e.g., “if a VM is moved to host H1, within 10 minutes that VM loses connectivity”). This allows an administrator to validate (or rule out) hypotheses as to the root cause of certain problems (e.g., migration to host H1) as well as detect when problems start to occur and correct these problems proactively.

In some embodiments, the temporal assertion that the framework is provided to evaluate is expressed as a linear temporal logic (LTL) assertion. Such an assertion is given as a set of predicates to apply to a set of network entities and a relationship across the time duration between the predicates for each network entity. In some embodiments, the user provides the assertion in LTL format, while in other embodiments the user provides the assertion in natural language (e.g., as in the examples given above) and the framework (e.g., the parser 105) translates the assertion into LTL format.

LTL assertions describe the evolution of a system (in this case, the datacenter or network) in discrete time intervals, using a combination of Boolean variables, Boolean operators, and temporal operators. These temporal operators evaluate whether predicates (expressions of Boolean variables) are true at a current time interval or in the future, in some cases based on the truth value of other predicates at the same or other time intervals. For example, a predicate for a virtual machine (VM) could state that the IP address is equal to a specific value, the number of current connections is greater than a specific number, etc. An example temporal assertion using multiple predicates is, e.g., “any VM migrated to a particular host (H1) loses connectivity after 10 minutes”. The following are examples of temporal operators, in which y and o are used to represent Boolean variables (predicates):
Gψ (Always ψ): ψ always holds from the current point in time
Fψ (Finally ψ): ψ holds at some point in the future
Xψ (Next ψ): ψ holds in the next time interval (time step)
ψUϕ (ψUntil ϕ): ψ holds at some point in the future and ψ holds from now until that point
ψWϕ (ψWeak Until ϕ): ψ holds until ϕ holds; if ϕ never holds, then ψ holds forever
ψRϕ (ψRelease ϕ): ϕ holds until and including once y holds; if ψ never becomes true, then ϕ holds forever

In addition to the temporal assertion, the framework is also provided with the set of network entities (the scope) for which to evaluate the temporal conditions. The scope can be broad (e.g., all virtual machines (VMs), all network elements, etc.), extremely narrow (a specific VM or container, a specific network element, a specific application, etc.), or in between (e.g., all VMs on a specific host, all hosts in a particular rack of the datacenter, all hosts with at least a particular number of VMs, etc.). In some embodiments, the network is a datacenter network and the type of network entities within the scope may be any entities in the datacenter for which data is collected on a regular basis.

In some embodiments, the scope is defined as a search query into a network data storage (e.g., a storage compiled for a separate application). For instance, some embodiments use the network storage of a network monitoring and/or evaluation application. The network data storage, in some embodiments, stores information about the network entities (e.g., VMs, containers, host computers, physical and/or logical forwarding elements, physical and/or logical middlebox elements, etc.) over time. That is, the network data storage includes both current and historical data for the network entities. In addition, the network data storage provides an API for enabling the stored data to be retrieved about specific entities, entities meeting certain conditions, and/or specific types of entities.

Next, the process 200 parses (at 210) the assertion into a tree of predicates and operators. Predicates are statements about an entity that are either true or false. Thus, for example, a predicate can compare a piece of data about an entity to a value (e.g., if VM CPU usage is <80%), but cannot simply use such a value (e.g., VM CPU usage is not itself a predicate as it does not have a truth value). The operators include temporal operators (e.g., the LTL operators described above) as well as standard Boolean operators (e.g., AND, OR, NOT).

The process 200 then traverses (at 215) the parse tree in order to identify cases for which a constant value for a single predicate determines the evaluation of an assertion. As described below, this can be used to reduce the scope of entities for which the assertion needs to be evaluated by a model checker. As a simple example using Boolean logic, the expression A∨B is always true if A is always true. Similarly, the temporal expression G ψ will evaluate to true if ψ is always true (as this is the definition of the operator G). In some embodiments, the query optimizer 110 is configured with a set of expressions that can be reduced if a predicate in the expression is always true or always false. For instance, some embodiments use the following rules for simplification:
G ψ is true if ψ is always true and is false if ψ is always false
Fψ is true if ψ is always true and is false if ψ is always false
¬ψ is false if ψ is always true and is true if ψ is always false (this is standard Boolean logic applied across time)
ψUϕ is true if ϕ is always true and is false if ϕ is always false.
ψ∧ϕ is false if at least one of ψ and ϕ is always false (this is standard Boolean logic applied across time)
ψ∨ϕ is true if at least one of ψ and ϕ is always true (this is standard Boolean logic applied across time)

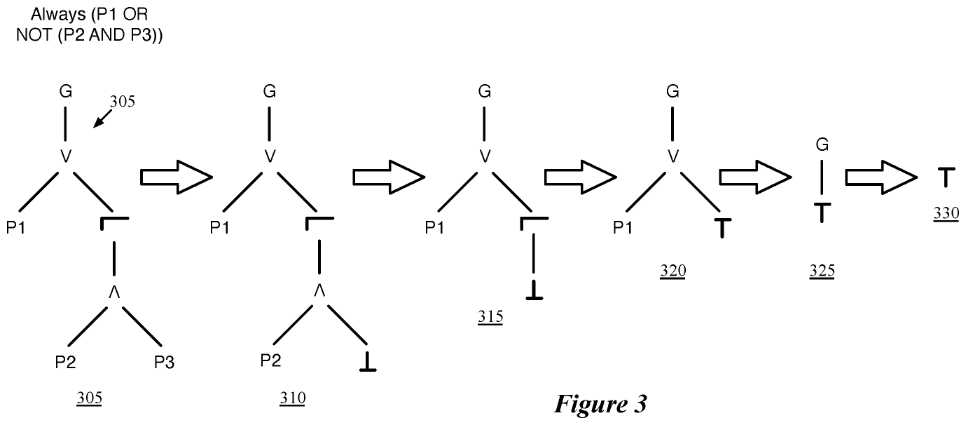

Based on these rules, the query optimizer 110 generates a list of cases in which a single predicate always being true or always being false makes the entire assertion true or not. FIG. 3 conceptually illustrates the reduction of a parse tree 300 over six steps 305-330. In this case, the parse tree 300 represents the expression G(P₁∨¬(P₂∧P₃) and the steps represent the reduction of the parse tree when P₃ is known to always be false. For instance, this might represent the assertion “For any VM, either the VM has connectivity or the VM is not a web server residing on host H1”. In this case, P₁ is “connectivity==true”, P₂ is “tag==web server”, and P₃ is “host==H1”.

The first stage 305 illustrates the entire parse tree for this expression, while the second stage 310 illustrates that the truth value false has been substituted for P₃ to determine whether the expression completely reduces in this case or not. The third stage 315 illustrates that the AND statement (P₂∧false) reduces to a truth value of false in this case. Next, stage 320 illustrates that the NOT statement is now ¬false, which reduces to true. In stage 325, the OR statement (P₁∨true) reduces to true. Finally, stage 330 illustrates that the temporal operator G (true) reduces to true, such that if P₃ is always false then the entire expression is always true. This makes sense in terms of the natural language assertion, in that if a VM never resides on host H1 then the expression is true for that VM. In addition, this assertion simplifies to true when P₂ is always false (for a similar reason as P₃ always being false) and when P₁ is always true. In some embodiments, as a given assertion will typically not have too many predicates, the query optimizer checks each truth value (true or false) for each predicate in the assertion to determine whether or not the predicate having that truth value throughout the time duration completely reduces the assertion. Some embodiments test larger combinations of predicates having constant truth values throughout the time duration (e.g., P₂ and P₃ both being true) to determine whether such combinations can reduce the assertion, while other embodiments only test individual predicates.

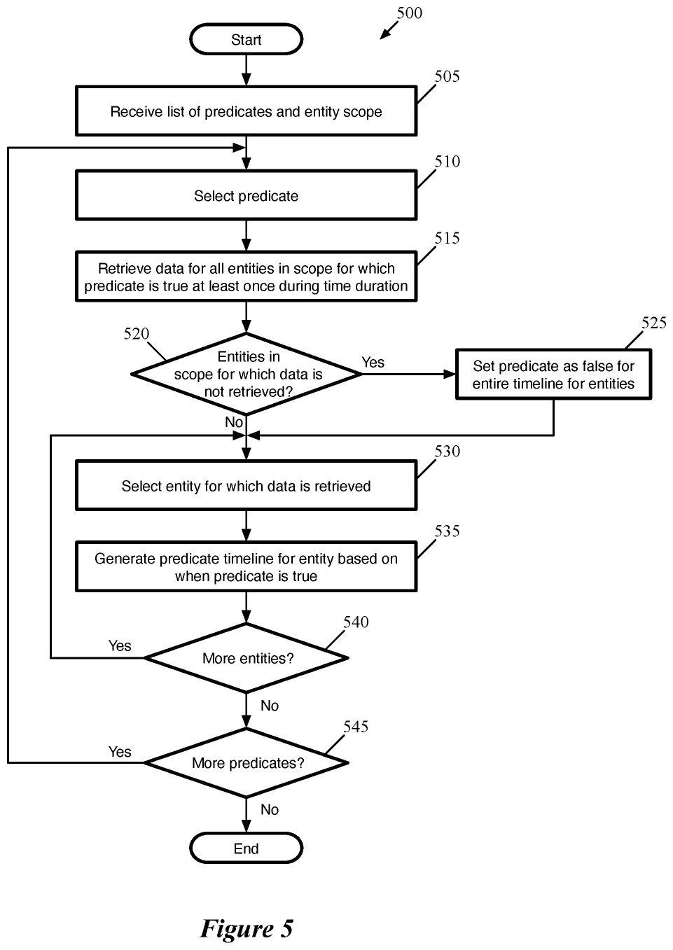

Returning to FIG. 2, the process 200 retrieves (at 220) network data for entities in the scope and determines, for each predicate, a timeline for each entity in the scope. As noted above, in some embodiments the query optimizer 110 retrieves this data from a separate application (e.g., a network monitoring and/or verification application). The timeline for each entity/predicate combination, in some embodiments, specifies a truth value for each time interval for a given predicate (for one entity) throughout the time duration. In some embodiments, time intervals are specified by the network administrator or are fixed by the evaluation framework 100. For instance, different embodiments may use 1-minute intervals, 5-minute intervals, etc. The value of a predicate, in some embodiments, is the value at the end of that time interval. Thus, if connectivity is up initially, goes down at two minutes, and is back up at 6 minutes, then (assuming 5-minute intervals) the initial truth value for “connectivity==Up” is true but is then false after one time step (at 5 minutes). On the other hand, if connectivity came back up at 4 minutes, then the truth value would be true throughout. Rather than storing a value for each time interval, some embodiments store the timeline as a list of points in time at which the truth value for the predicate changes. A more detailed description of the timeline-generation process of some embodiments will be described below by reference to FIG. 5.

The process 200 then reduces (at 225) the entity scope by evaluating the assertion for entities with a single value for one or more predicates across their timeline. That is, based on the parse tree traversal at 215, the query optimizer 110 can quickly determine, for each entity, whether the assertion can be reduced for that entity. As an example, if the assertion is “migration to host H1 causes a VM to lose connectivity within 10 minutes”, then the initial scope is all VMs in the datacenter. However, for any VM that never resides on host H1 (i.e., host==H1 is false for the entire timeline), this assertion can quickly be reduced. In a typical datacenter with many hosts and VMs, this will drastically reduce the scope from an extremely large number (all VMs) to a much more reasonable number (just the VMs that operate on host H1 during the time period), which is beneficial computationally (reducing the number of assertions that the model checker needs to evaluate).

Next, the process 200 generates (at 230) a program having arrays of predicates for each entity that can be analyzed by the model checker. In some embodiments, the program is generated in a language compatible with the model checker used for evaluation. This may be a commonly used programming language (e.g., C, C++, etc.) or a language specific to the model checker. For instance, some embodiments use the SPIN model checker and thus generate the program in the Promela language that is designed for that model checker. The program, in some embodiments, does not itself include the assertions, but rather is a holder for the Boolean variables representing predicate values over time for each entity in the scope.

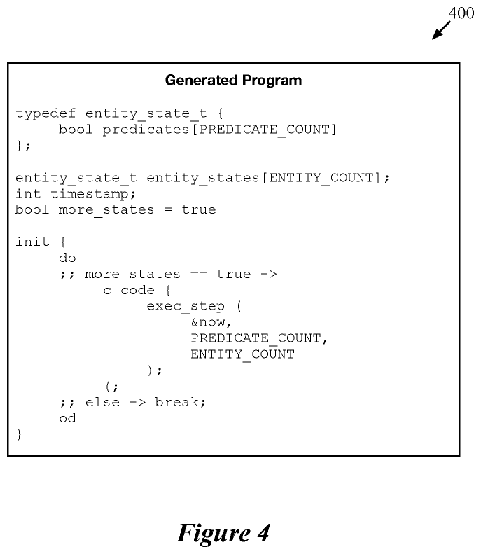

FIG. 4 illustrates a simplified version of such a program 400. In the program 400, for each relevant entity in the datacenter/network (i.e., each entity for which the assertion could not be reduced based on constant truth values for one of the predicates), a struct entity_state_t is defined. For a given entity, the struct entity_state_t stores all of the predicate truth values (Boolean values), in the predicates array. Thus, an array of these structs represents the state for all entities at a given time. The program itself executes in a loop, with each iteration representing a subsequent time interval, and continues until the more_states variable is false. This occurs when the time window for analysis (the time duration) has reached its end. In each iteration, the program uses an embedded API call to the predicate API 115 to fill in all of the predicate values for each entity in the scope. These API calls update the Boolean predicate variables for each entity to match the truth value of the corresponding predicate at that point in time in the network. As described, these predicate values are quickly known to the predicate API 115 based on the stored predicate timelines 155.

In addition to generating the program, the process 200 also generates (at 235) a set of assertions, using the variables of the generated program, to be evaluated by the model checker. The model checker (e.g., the Spin model checker) validates assertions about the program, and thus these assertions should be written in the variables of the program (i.e., the same Boolean variables and structs as the program). As an example, for the assertion “VMs on host H1 become disconnected within 10 minutes”, two predicates “host==H1” (predicates[0]) and “connection_state==disconnected” (predicates[1]) are defined. This assertion for a particular VM (represented as entity_states[0]) is expressed as:

G(!entity_state[0].predicates[0]∥entity_states[0].predicates [1]∥X entity_states[0].predicates[1]∥XX entity_states[0].predicates[1])

In this expression the operators G and X are the Always and Next operators as described above, while the ∥ operator represents the Boolean OR operator. That is, the assertion states that, always, either the VM is not on host H1 or the VM is disconnected in at least one of the current state, the next state, or two subsequent states (assuming a time interval of 5 minutes).

Some embodiments generate assertions for each entity in in the scope. In some embodiments, the evaluation framework generates separate assertions for each entity, so that the number of assertions provided to the model checker is equal to the number of entities in the scope. However, certain model checkers (i) only check a single assertion per execution and/or (ii) only support a maximum number of assertions. Thus, some embodiments generate batches assertions such that each assertion provided to the model checker covers a group of entities. These assertions are essentially conjunctions of individual assertions formed by ANDing together assertions for the individual entities. Grouping assertions together comes with some downside as well, in that the assertions can take longer for the model checker to evaluate and the results may be more difficult to review. Thus, if there are a large number of entities, the framework typically does not group all of the assertions together, but rather uses small groups of assertions to cut down on the number of times the model checker needs to execute the program while ensuring that the results remain comprehensible. Still other embodiments run multiple instances of the model checker in parallel, each instance checking one assertion (or a separate small batch of assertions).

Once the program and assertions are generated, the process 200 evaluates (at 240) the assertions by executing the program to generate values for the predicate variables for each entity (at each time interval) and checking the assertions against these generated values at each time interval. In some embodiments this execution and evaluation is performed by the model checker 120. This model checker, as noted, may be part of the evaluation framework (e.g., a module belonging to the same program as the query optimizer, predicate API, etc.) or an external model checker program (e.g., an existing explicit-state model checker).

The process 200 then provides (at 245) an indication as to which of the entities passed and which entities failed the temporal assertion over the time duration. In some embodiments, as shown in FIG. 1, this information is output directly from the model checker 120 to the user. In other embodiments, the model checker provides the results back to the verification framework, which synthesizes the information and provides the user with the data (i.e., specifying entities that passed or failed the verification). This data may enable the user to verify that the network (or datacenter more generally) is operating properly or to identify a specific problem with the network.

As noted, FIG. 5 conceptually illustrates a process 500 of some embodiments for generating the entity-predicate timelines. In some embodiments, the process 500 is performed by the query optimizer 110, the predicate API 115, or another module of a temporal assertion evaluation framework such as that shown in FIG. 1. The process 500 is performed prior to reduction of the entity scope, as the reduction operation relies on the predicate timelines gathered by the process 500. It should be understood that the process 500

As shown, the process 500 begins by receiving (at 505) a list of predicates and the entity scope. In different embodiments, the list of predicates may be part of the data received from the user by the evaluation framework or may be generated by the framework based on a more generally written assertion to be evaluated. As noted, the entity scope is the scope as provided from the user, prior to scope reduction.

The process 500 then selects (at 510) one of the predicates. The predicates may be selected in the order they appear in the assertion or in another order (e.g., a random order). Furthermore, it should be understood that the process 500 is a conceptual process and that some embodiments, rather than selecting each predicate one after the other, performs operations in parallel to generate the timelines for each predicate.

The process 500 retrieves (at 515) data for all of the entities in the scope for which the predicate is true at least once during the time duration. In some embodiments, the search API 150 for the network data storage is such that one API call can be made to retrieve all entities within a scope for which a given predicate (e.g., “VM is on host 1”, “switch has more than 100 connections”, etc.) is true at least once during the time window. In addition, in some embodiments, this API call returns the specific points in time when the predicate is true.

The process 500 then determines (at 520) whether there are entities in the scope for which no data is retrieved (for the current predicate). As noted, the process only retrieves data for an entity if the predicate is true at some point during the time window. As such, the process sets (at 525) the predicate as false for the entire timeline for any such entities (i.e., entities for which the API call does not retrieve any data).

Next, the process 500 generates the timelines for the entities for which data was retrieved. The process 500 selects (at 530) an entity for which data was retrieved and generates (at 535) a predicate timeline for the entity based on when the predicate is true. To generate the timeline for an entity, the query framework identifies the points in time at which the predicate is true (based on the retrieved data) and then fills in the predicate as false for all other times. Some embodiments store each timeline as a set of times at which the truth value for the predicate changes (in order to reduce the amount of data required for each timeline), while other embodiments store the truth value for the predicate at each time interval within the time window.

Some embodiments also enable generation of timelines for event-based predicates. Event-based predicates indicate whether a particular type of event occurred within a time interval. For instance, the assertion “No VM should migrate more than once in a 1-hour window” is not easy to evaluate using typical predicates, because migration is not a state that can be verified easily as a Boolean variable. However, in some embodiments the network data stores a history of change events; when the network monitoring application detects a change, it generates a notification to users that can be retrieved. In some embodiments, the verification framework can review these change events (e.g., by reviewing the notification times for specific types of events). When a notification occurs during a time interval, then the predicate is marked as true for that time step. In the next time step, the predicate returns to being false (unless there is another change event in that next time interval).

After generating the timeline for the current entity, the process 500 then determines (at 540) whether additional entities remain to have timelines generated for the current predicate. If additional entities remain, the process 500 returns to 530 to select the next entity. As noted previously, the process 500 is a conceptual process and does not necessarily perform the operation 535 for each entity one at a time. Rather, some embodiments perform these operations in parallel for multiple entities.

Once the timelines for all of the entities have been generated for the current predicate, the process 500 determines (at 545) whether additional predicates remain in the assertion for which the timelines need to be generated. If additional predicates remain, the process 500 returns to 510 to select the next predicate. Once all of the timelines are generated for all of the predicates, the process 500 ends. At this point, the framework can perform scope reduction, generate a program and assertions for the model checker, and evaluate the assertion for all of the entities in the remaining scope.

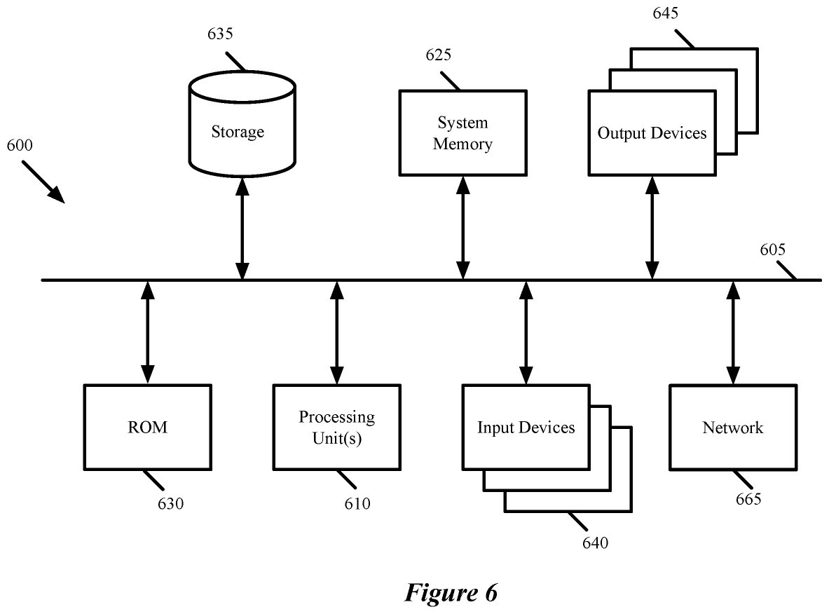

FIG. 6 conceptually illustrates an electronic system 600 with which some embodiments of the invention are implemented. The electronic system 600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the electronic system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments.

The read-only-memory (ROM) 630 stores static data and instructions that are needed by the processing unit(s) 610 and other modules of the electronic system. The permanent storage device 635, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device. Like the permanent storage device 635, the system memory 625 is a read-and-write memory device. However, unlike storage device 635, the system memory is a volatile read-and-write memory, such a random-access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the electronic system. The input devices 640 include alphanumeric keyboards and pointing devices (also called “cursor control devices”). The output devices 645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples electronic system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of electronic system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the FIGS. (including FIG. 2) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for validating behavior in a network over a duration of time, the method comprising:
receiving a set of conditions for the network over a time duration;
automatically generating a program that comprises a set of variables representing the set of conditions at given time intervals;
querying a set of network data across the time duration to determine values for the variables at each time interval over the time duration; and
using a model checker that analyzes the program with the determined values for the variables to determine whether the set of conditions are met for the network over the time duration.

2. The method of claim 1, wherein the set of conditions is expressed as a linear temporal logic (LTL) assertion that comprises a set of predicates to apply to a set of network entities and a relationship across the time duration between the predicates for each of the network entities.

3. The method of claim 2 further comprising receiving a search query that defines the set of network entities for which the LTL assertion is evaluated.

4. The method of claim 2, wherein each predicate is represented in the generated program as a Boolean variable that depends on the network data for the set of network entities at the time intervals.

5. The method of claim 4, wherein querying the set of network data comprises, for each predicate in the set of predicates:
retrieving data for each entity in the set of entities from a network data storage to determine a truth value for the predicate for each entity at each time interval; and
for each entity, storing a timeline of the truth value for the predicate.

6. The method of claim 5 further comprising, prior to generating the program, reducing a number of network entities in the set of network entities for which the program comprises variables based on the truth values for the predicates.

7. The method of claim 6, wherein reducing the number of network entities comprises:
identifying, for a particular entity, that a particular predicate has a same particular truth value for the entire time duration; and
determining that the particular predicate having the particular truth value for the entire time duration automatically determines whether the assertion is met for the particular entity irrespective of the truth values of other predicates for the entity.

8. The method of claim 5, wherein the model checker analyzes the program by executing the program to iteratively update values of the Boolean variables for each time interval and determine whether the assertion is met at that time interval.

9. The method of claim 8, wherein the values of the Boolean variables are stored in arrays for each of the network entities in the set of network entities.

10. The method of claim 8, wherein the model checker updates the Boolean variables by making API calls to the stored timelines of truth values for the predicates.

11. The method of claim 1, wherein the program is generated in a particular language supported by the model checker.

12. A non-transitory machine-readable medium storing a first program which when executed by at least one processing unit validates behavior in a network over a duration of time, the first program comprising sets of instructions for:
receiving a set of conditions for the network over a time duration;
automatically generating a second program that comprises a set of variables representing the set of conditions at given time intervals;
querying a set of network data across the time duration to determine values for the variables at each time interval over the time duration; and
using a model checker that analyzes the second program with the determined values for the variables to determine whether the set of conditions are met for the network over the time duration.

13. The non-transitory machine-readable medium of claim 12, wherein the set of conditions is expressed as a linear temporal logic (LTL) assertion that comprises a set of predicates to apply to a set of network entities and a relationship across the time duration between the predicates for each of the network entities.

14. The non-transitory machine-readable medium of claim 13, wherein the first program further comprises a set of instructions for receiving a search query that defines the set of network entities for which the LTL assertion is evaluated.

15. The non-transitory machine-readable medium of claim 13, wherein each predicate is represented in the generated second program as a Boolean variable that depends on the network data for the set of network entities at the time intervals.

16. The non-transitory machine-readable medium of claim 15, wherein the set of instructions for querying the set of network data comprises sets of instructions for, for each predicate in the set of predicates:
retrieving data for each entity in the set of entities from a network data storage to determine a truth value for the predicate for each entity at each time interval; and
for each entity, storing a timeline of the truth value for the predicate.

17. The non-transitory machine-readable medium of claim 16, wherein the first program further comprises a set of instructions for, prior to generating the second program, reducing a number of network entities in the set of network entities for which the second program comprises variables based on the truth values for the predicates.

18. The non-transitory machine-readable medium of claim 17, wherein the set of instructions for reducing the number of network entities comprises sets of instructions for:
identifying, for a particular entity, that a particular predicate has a same particular truth value for the entire time duration; and
determining that the particular predicate having the particular truth value for the entire time duration automatically determines whether the assertion is met for the particular entity irrespective of the truth values of other predicates for the entity.

19. The non-transitory machine-readable medium of claim 16, wherein the model checker analyzes the second program by executing the second program to iteratively update values of the Boolean variables for each time interval and determine whether the assertion is met at that time interval.

20. The non-transitory machine-readable medium of claim 19, wherein the values of the Boolean variables are stored in arrays for each of the network entities in the set of network entities.

21. The non-transitory machine-readable medium of claim 19, wherein the model checker updates the Boolean variables by making API calls to the stored timelines of truth values for the predicates.

22. The non-transitory machine-readable medium of claim 12, wherein the second program is generated in a particular language supported by the model checker.
